(19) United States
(12) Patent Application Publication
(10) Pub. No.: US 2008/0245262 A1
(43) Pub. Date: Oct. 9, 2008

(54) Thixotropic Coating Materials

(76) Inventors: Reinhard Stotzel, Borken (DE); Markus Kahl, Essen (DE)

Correspondence Address: KAGAN BINDER, PLLC, SUITE 200, MAPLE ISLAND BUILDING, 221 MAIN STREET NORTH, STILLWATER, MN, 55082, US

(21) Appl. No.: 11/663,014

(22) PCT Filed: Sep. 9, 2005
(86) PCT No.: PCT/EP2005/009725

§ 371 Date: Feb. 8, 2008

(30) Foreign Application Priority Data
Sep. 15, 2004 (DE) 102004044662.8

(51) Int. Cl. C09D 5/04; C09D 129/04; C09D 125/06; C08K 3/34; C09D 133/02; C09D 131/04; B28B 7/38

(52) U.S. Cl. 106/18.31; 106/316; 106/287.17; 106/151.2; 106/210.1; 106/205.2; 524/447; 524/445; 106/38.22; 427/133

(57) ABSTRACT

The present invention relates to novel thixotroping agents and coating materials containing the same as well as the production and use thereof, wherein the thixotroping agent comprises a layered silicate and an organically modified phosphate.

The present invention relates to novel thixotroping agents and coating materials containing the same as well as the production and use thereof.

Thixotropic paints have become increasingly important in technical applications for some time now. Such paints have a gel-like structure which collapses when subjected to the shear forces generated during application and then reinstates itself in a state of rest. Compared to non-thixotropic paints, this can reduce or even prevent dripping.

Furthermore, such thixotropic paints allow coatings without curtaining and a tendency to run off, and the layer thickness of the coatings can be higher as well. In particular, a certain running or flowing of the paint can be guaranteed in painting or spraying applications so that strokes of a brush or spray blobs can level off without the paint itself running off.

The gel-like structure of these thixotropic paints can range from light gels to thick gels and can even be increased to such an extent that in a state of rest the paint assumes a solid form (what is known as solid paint).

One group of the so-called thixotropic paints is based on curable aqueous binder systems wherein the paint can additionally contain pigments, fillers and other common additives (such as for example preservatives). In order to obtain the thixotropic properties, a thickening colloid and a chelate complex can be added to the thixotropic paints as structure-formers.

For example, the patent DE 1 242 306 describes a water-dilutable coating agent with thixotropic properties on the bases of a film-forming homo- or copolymer of vinyl esters, acrylic and methacrylic acid esters, styrene, acrylonitrile and butadiene, to which a hydroxy group-containing organic colloid in the form of starch or cellulose derivatives and a titanium chelate are added.

Furthermore, EP-A-0 144 135 describes a solid paint which essentially consists of a latex polymer dispersion, a thickening colloid, preferably cellulose-based, as well as clays, zirconium chelate and/or titanium chelate as structuring agent.

However, there are sometimes problems with such paints known from the prior art, in particular with respect to the selection of suitable dispersion binders since their minor constituents such as protective colloids, which are added to stabilize the dispersion, can often interfere with or even prevent the thixotropic effect.

The adjustment and stability of the viscosity and the thixotropic effect pose another problem, in particular when the thixotropic properties of the paint are attributed to the physical crosslinking of hydroxy group-containing colloids and the titanium chelate via hydrogen bridge bonds. In this case, the problem of a disadvantageously slow crosslinking rate can arise which necessitates long storage periods (weeks to months) until stable viscosity values can be obtained. The laid-open document DE-A1-36 34 183 was able to offer solutions to these problems. It was found that the thickening colloid does not have to comprise free OH groups at all and that therefore a thixotropic coating material can be provided which, in addition to a chelate complex, comprises a polysaccharide reacted with a primary or secondary amine and/or an amino-functional silane, which polysaccharide no longer contains free hydroxy group and has a total molecular weight of at least 2 million.

At this point, the problem of obtaining the desired thixotropic properties while using binders that are not based on dispersion remains largely unsolved in the technical field. Usually, theological additives on the basis of association or polyurethane thickeners are used for this purpose. However, the use of such thickening agents also leads to a strong interaction with the system so that a complicated optimization of the various paints is required in those cases as well.

It was therefore an object of the present invention to provide a thixotroping agent exhibiting low interaction with the typical components of coating materials, in particular various binders, which therefore has a broader range of application compared to the thickening agents of the prior art.

According to the present invention, these problems are solved by a thixotroping agent comprising a layered silicate and an organically modified phosphate.

Furthermore, the invention is directed to coating materials comprising such a thixotroping agent.

The invention is also directed to a process for the production of a coating material according to the present invention, characterized in that a thixotroping agent according to the present invention is incorporated into a carrier liquid.

Furthermore, the invention is directed to a process for coating a body with a coating material, comprising the steps of
a) providing a coating material according to the invention;
b) applying the coating material to a body;
c) drying the coated body; and
d) optionally curing the coating material.

Moreover, the invention is directed to a coated body onto which the coating material according to the present invention has been applied, and the use of the coating material according to the present invention for coating a body.

Finally, the invention is directed to the use of a thixotroping agent according to the present invention for controlling the thixotropy and application behavior of a coating material for a body.

The present invention is based on the surprising finding that by adding an organically modified phosphate to a layered silicate as a thickening agent, a thixotroping agent can be provided which can be used universally for controlling the thixotropy and thus the application behavior of coating materials containing such a thixotroping agent, largely independently of what binder system is used. In addition to the resulting independence in the selection of a binder system to be used in a coating material, the use of the thixotroping agent according to the present invention furthermore ensures that the coating material can comprise an increased solids content compared to conventional coating materials due to an additional liquefying effect which can be obtained by the addition of the organically modified phosphate.

Basically, all layered silicates capable of imparting thixotropic thickening properties to coating materials due to their swelling behavior can be used as layered silicates in the thixotroping agent according to the present invention. The layered silicates according to the present invention are preferably clay minerals known in the art by the classification “two-layer silicate” and “three-layer silicate”. Such layered silicates include for example attapulgite, serpentines, kaolinites, pyrophyllite, smectites, such as saponite, hectorite, montmorillonite, beidellite and nontronite, vermiculite, illite and mica. In a preferred embodiment, the layered silicate is selected from attapulgite and montmorillonite-containing clays, such as for example bentonite. According to the present invention, attapulgite is especially preferred. For example, a product from the company Engelhardt Engelhard Corporation, Iselin, N.Y., USA, with the trade name “Attagel 40” can be used as attapulgite.

In a thixotroping agent according to the present invention, combinations of different layered silicates at any desired ratios can be used as well. Preferably, the layered silicates used in the present invention have a particle size of 0.1 to 20 μm.

Inorganic phosphate salts which have been modified by the addition of organic compounds can be used as organically modified phosphate according to the present invention.

Preferred inorganic phosphate salts include compounds of the general formula

(H₂PO₄)₃M

which were preferably reacted with an organic amine, in particular an aliphatic amine, especially preferred a hydroxyalkyl amine, which usually leads to a neutralization of the phosphate salt. The above-mentioned aliphatic amine usually comprises 1 to 20, preferably 1 to 4, carbon atoms. The alkylene group in the ω-hydroxyalkyl amine can comprise 1 to 20 carbon atoms, preferably 1 to 4 carbon atoms, with an alkylene group selected from CH₂, CH₂CH₂ or CH₂CH₂CH₂ being preferred. The ω-hydroxyalkyl amine can comprise 1, 2 or 3 hydroxyalkyl groups at the amine nitrogen which can be the same or different. Triethanolamine is especially preferred. The symbol M represents a cation selected from Al³⁺ and/or cations of the group of alkaline-earth metals, in particular calcium or magnesium. Upon reaction with an organic amine, in particular a ω-hydroxyalkyl amine, the remaining protons of the above-mentioned inorganic phosphate salts are partially or completely replaced with the corresponding ω-hydroxyalkyl ammonium compound. The organically modified phosphate of the present invention should at least partially be soluble in the carrier liquid of the coating material at a temperature of 15 to 25° C., preferably at about 20° C. The organically modified phosphates of the present invention are preferably soluble in the carrier liquid of the coating material at about 20° C.

In an especially preferred embodiment, the organically modified phosphate is an aluminum phosphate modified with triethanolamine, in particular a triethanolammonium monoaluminum phosphate. As an example, reference is made to the phosphate with the trade name “Fabutit 703” which can be used in the present invention. It is commercially available from the company Chemische Fabrik Budenheim, Budenheim.

In a thixotroping agent according to the present invention, the layered silicate and the organically modified phosphate can preferably be used in a weight ratio of 1:2 to 20:1, more preferred 1:1 to 10:1, and particularly preferred 2:1 to 5:1. If the amount of added organically modified phosphate is too low, no sufficient thixotropy is obtained while too high an amount of added phosphate has a strong liquefying effect which causes the composition to lose the favorable thixotropic properties according to the present invention.

In a preferred embodiment, a thixotroping agent according to the present invention merely comprises the components layered silicate and organically modified phosphate, wherein it is especially preferred that they be present in the ratios mentioned above.

A thixotroping agent according to the present invention can be used to control the thixotropy and application behavior of a coating material for a body.

The coating materials according to the present invention preferably comprise 0.1 to 10 wt.-% of the layered silicate and 0.1 to 5.0 wt.-% of the organically modified phosphate. In an especially preferred embodiment, a coating material according to the present invention comprises 0.1 to 5.0 wt.-% of the layered silicate and 0.1 to 2.0 wt.-% of the organically modified phosphate.

Preferably, a coating material comprises a carrier liquid. The solid components of the coating material can form a suspension with the carrier liquid which renders the solid components workable so that they can be applied by means of a suitable process, such as e.g. dipping, brushing, or spraying, onto a body to be coated. Optionally, the solid components of the coating material can be reacted with the carrier liquid to form a suspension with the help of common suspending agents, such as surfactants, for example disodium dioctylsulfosuccinate. In a preferred embodiment, a coating material according to the present invention comprises a carrier liquid, wherein the carrier liquid comprises water as the main component. In addition to water as the main component, the carrier liquid of the present invention can furthermore comprise alcohols, such as for example methanol, ethanol, n-propanol, isopropanol, n-butanol, in an amount of up to 20 wt.-%, based on the carrier liquid, preferably 5 wt.-%, and in particular 2 wt.-%. In an especially preferred embodiment, water is the sole carrier liquid in a coating material according to the present invention.

As a purposive component, the coating materials preferably contain at least one basic substance. The purpose of this basic substance is mainly to influence the surface of the body to be coated. Thus, the nature of the basic substance to be used primarily depends on the desired surface treatment of the body to be coated, and according to the present invention it is not limited to a specific application. For example, in foundry technology, a filler such as zirconium silicate or aluminum silicate can be used as a basic substance which seals the pores of a foundry core or molded article in order to prevent the casting metal from penetrating. If the coating materials are paints and varnishes, pigments are primarily used as basic substances whose purpose is to impart a color coating to the surface to be treated. The basic substances, when present as solid components, usually have a particle size of 0.1 to 200 μm, preferably 1 to 100 μm.

As a rule, it is advantageous in the various technical fields to be able to provide coating materials with as high a solids content as possible of 20 to 80 wt.-%, preferably 40 to 60 wt.-%, i.e. as high a ratio of solid component (in particular the basic substance described above) to carrier liquid. Such technical fields include for example facing paints (e.g. zirconium silicate or aluminum silicate as basic substance) and wall paints. In the case of wall paint, for example, the need for as high as possible a solids content can be explained with a better coverage of the paint. However, conventional coating materials which have been imparted sufficient thixotropic properties by means of a thixotroping agent known in the prior art generally have the disadvantage that the resulting coating materials exhibit an unfavorably high viscosity at a high shear rate. High viscosities at a high shear rate can, however, have the disadvantage that the coating material is difficult to process. In order to guarantee a sufficiently good workability of such coating materials, it is therefore necessary to increase the amount of carrier liquid which is the equivalent of disadvantageously decreasing the solids content.

Coating materials comprising a thixotroping agent according to the present invention, on the other hand, allow for a considerably higher solids content compared to conventional coating materials without it affecting the thixotropic properties of the material.

For its use in foundry technology, a preferred embodiment of a coating material according to the present invention comprises a refractory material or filler as a basic substance. All conventional refractory materials can be used as refractory material. For example, aluminum silicate, mica, zirconium silicate, iron oxide, bauxite, olivine, aluminum oxide, quartz, talcum, titanium oxide and/or graphite can be used alone or in admixture with one another at any desired mixing ratios. Substances such as zirconium silicate or aluminum silicate can be used as fillers as basic substance. Aluminum silicate, mica, zirconium silicate and/or graphite are especially preferred refractory materials. When the coating materials of the present invention are used for facing paints, substances such as e.g. zirconium silicate or aluminum silicate can be used as basic substances. The refractory material or filler are preferably present in the coating material in an amount of 20 to 80 wt.-%, and in particular 40 to 60 wt.-%.

In another preferred embodiment which can be used to produce paint coats on walls and ceilings as well as wall and ceiling dressings, in particular wallpaper, a coating material according to the present invention comprises a pigment as a basic substance. All materials known and common in the art can be used as pigments, in particular natural and synthetic inorganic and natural and synthetic organic pigments and mixed pigments. Especially preferred pigments are selected from calcium carbonate, titanium dioxide, quartzite and talcum. The pigment is preferably present in the coating material in an amount of 20 to 80 wt.-%, and in particular 40 to 60 wt.-%.

Preferably, the coating materials according to the present invention furthermore comprise a binder which preferably accounts for 0.2 to 50 wt.-% of the coating material. It is especially preferred that the binder be present in an amount of 0.4 to 2 wt.-% in facings and 20 to 40 wt.-% in paint coats. The purpose of the a binder is mainly to guarantee curing of the ingredients of the coating material, including the basic substance, after drying of the coating material applied onto a body. Preferably, the binder cures irreversibly and thus leads to an abrasion-resistant coating on the body. Abrasion resistance is of great importance for the finished coating material since a lack of abrasion resistance can result in damage to the coating. In particular, the binder should not soften when exposed to atmospheric moisture. In preferred embodiments, curing of the binder is carried out in a known manner. For example, in acrylate systems curing can be carried out using radical formers which, for example, form free radicals when irradiated with UV light.

According to the present invention, all binders can be used which are typically used in aqueous systems. It is a special advantage of the present invention that the thixotroping agent of the present invention can be used in a wide range of different binder systems and no interactions with the binder systems have been observed which would affect the thixotropic properties. For example, starch, dextrin, peptides, polyvinyl alcohol (e.g. polyviol; commercially available as a solution from Wacker Polymer Systems GmbH & Co. KG, Burghausen), polyvinyl acetate copolymer (e.g. Airflex; commercially available from Wilhelm E. H. Biesterfeld, Hamburg), polyacrylic acid, polystyrene-, and/or polyvinyl acetate-polyacrylate dispersions can be used as binders. In an especially preferred embodiment, the binder comprises starch, e.g. an oxidized corn starch (commercially available from Carl Arnsperger, Cologne).

In addition to the components already mentioned above, the coating materials can comprise further additives, such as for example wetting agents, antifoaming agents, and/or biocides. Anionic and non-ionic surfactants with a medium to high polarity (HSB value of 7 and higher) known to the person skilled in the art are preferable used as wetting agents, preferably in an amount of 0.01 to 1.0 wt.-%, more preferred 0.1 to 0.5 wt.-%, based on the coating material. Silicone or mineral oil can for example be used as antifoaming agent. According to the present invention, formaldehyde, 2-methyl-4-isothiazoline-3-one (MIT), 5-chloro-2-methyl-4-isothiazoline-3-one (CIT) and/or 1,2-benzisothiazoline-3-one (BIT), preferably MIT and/or BIT, can be used as biocides. According to the present invention, antifoaming agents are used in an amount of 0.01 to 1.0 wt.-%, preferably 0.1 to 0.5 wt.-%, and biocides are used in an amount of 10 to 10,000 ppm, preferably 25 to 1,000 ppm, based on the coating material.

Coating materials according to the present invention can be prepared by introducing the described thixotroping agents into an aqueous binder system. By adding the thixotroping agent, it is possible to control the thixotropy and thus the application behavior of the coating material. For producing the coating material, the thixotroping agent is first opened up in the carrier liquid. For this purpose, the layered silicate is added to the carrier liquid in solid or pasty form and opened up by means of sufficiently high shear forces and stirring, e.g. 10 to 60 minutes at 300 to 1,000 rpm using a toothed disk (D/d=0.5). Depending on the compositions of the thixotroping agent, the opening-up period can be critical for an optimum dispersion of the solids added later on. Therefore, opening-up periods that are too short should be avoided in order to guarantee an optimum control of the thixotropic properties of the coating materials. After opening up the layered silicate in the carrier liquid, the organically modified phosphate can be added and mixed in homogeneously. Then the other components of the coating material, in particular the basic substances, can be added in any desired order. While it is possible to open up the layered silicate together with the organically modified phosphate, it is preferred that the layered silicate be opened up alone and the organically modified phosphate be added later.

For commercial distribution, a coating material according to the present invention can be formulated according to the process described above and provided as a ready-made coating material, e.g. as a facing or paint. Furthermore, the coating material according to the present invention can be distributed in pasty form. In this case, in order to provide a ready-to-use coating material, a suitable amount of carrier liquid has to be added which is necessary to adjust the required viscosity and density properties of the coating material. Additionally, the thixotroping agent and the coating material can be distributed as a mixture of powdery solids to which an appropriate amount of carrier liquid then has to be added to obtain a ready-to-use coating material. In a ready-to-use state, a coating material according to the present invention preferably comprises a solids content of 20 to 80 wt.-%, based on the solids content, especially preferred 40 to 60 wt.-%.

Depending on the intended purpose of the coating material, the particle size of the solids used therein can be relevant. For instance, if the coating materials according to the present invention are used to coat foundry cores or molds, sufficiently small particle sizes allow an advantageous surface smoothness of the casting. The particle sizes of the refractory materials used for this purpose according to the present invention are preferably between 1 and 500 μm, especially preferred between 10 and 150 μm. When the coating materials according to the present invention are used to glaze raw ceramic bodies, the particle size of the incorporated glaze batch is preferably no more than 100 μm.

Depending on the desired layer thickness of the coating substance to be applied, additional characteristic parameters of the coating material can be adjusted.

Accordingly, in a preferred embodiment, coating materials according to the present invention which are used to coat foundry molds and cores have a viscosity of 12 to 17 s, preferably 14 to 16 s (determined according to DIN 53211; flow cup 4 mm, Ford Cup) and preferably have a density of 20 to 50°Bé, especially preferred 25 to 35°Bé (determined according to the Baumé flotation weight loss method; DIN 12791).

The coating materials according to the present invention can be used to coat bodies. The use of the coating materials according to the present invention also encompasses the partial coating of bodies. The coating materials are suitable for all conceivable applications aimed at coating bodies with coatings on the basis of aqueous carrier liquids. The coating materials according to the present invention are especially suitable for coating foundry cores and molds. Examples of foundry cores and molds include sand cores bound with PUR ColdBox, water glass CO₂, MF resol, resol CO₂, furan resin, phenolic resin or water glass/ester. Other examples of preferred bodies which can be coated with the coating materials include walls and ceilings, as well as wall or ceiling dressings, in particular wallpapers. Examples of wallpapers are wood-chip, relief, textile, velours, paper, fleece, glass fiber, acrylic and vinyl wallpapers.

A process for coating a body with a coating material according to the present invention comprises the steps of
a) providing a coating material;
b) applying the coating material to a body; and
c) drying the coated body
d) optionally curing the coating material.

The coating material according to the present invention can be applied by means of all conventional application methods known in the art. Examples of preferred application methods are dipping, flow coating, spraying and brushing.

When dipping is used as an application method, the time required for the excess coating material to run off depends on the run-off properties of the coating material used. After a sufficiently long run-off time, the coated body is subjected to drying.

All conventional drying methods known in the art can be used as drying methods, for example air-drying, drying with microwaves or drying in a convection oven. In a preferred embodiment of the present invention, the coated body is dried in a convection oven at 100 to 250° C., especially preferred at 120 to 180° C. In another preferred embodiment, the body is air-dried without any further treatment.

According to the process of the present invention, bodies can be coated with the coating material in a single coating process step. However, depending on the desired dry layer thickness, multiple coating steps are possible as well. In a preferred embodiment, a body which was coated in a single coating step has a dry layer thickness of between 50 and 600 μm, with a dry layer thickness between 150 and 300 μm being especially preferred.

The invention will be explained in more detail in the following examples.

### EXAMPLES

### Example 1

Attapulgite (see Table 1) was opened up in water for 20 minutes at 20° C. For this purpose, the layered silicate is added to water and opened up by means of sufficiently high shear forces and stirring (1,000 rpm using a toothed disk (D/d=0.5). Then the other components of the coating material are added at 20° C., 1,000 rpm and 20 minutes of mixing time. Then Fabutit 703 and subsequently an antifoaming agent are added at 20° C., 800 rpm and 5 minutes of mixing time. The amounts given refer to parts by weight.

TABLE 1

| | |
|---|---|
| Water | 56.0% |
| Biocides | 0.30% of a ready-to-use solution of a biocide |
| | (content of active ingredient 100 ppm based on |
| | the total coating material) |
| Attapulgite | 2.30% |
| Starch (binder) | 0.40% |
| Aluminum silicate | 40.0% (particle size smaller than 200 mesh) |
| Fabutit 703 | 0.50% |
| Mineral oil | 0.50% |

The Theological properties were measured with a Haake Rheo Stress 1 rheometer by means of the measuring body CE 60 (cone-plate). A thixotropy of 240 Pas⁻¹ and a yield value of 18 Pa were obtained. These values are about three to ten times higher than in a conventional system and thus allow a good control of the thixotropy and yield value.

### Examples 2 to 14

Examples 2 to 14 are carried out analogously to Example 1, except that the components are added in the amounts and the order given below. First of all, a base stock comprising conventional refractory materials is prepared according to Table 2:

TABLE 2

| Base stock: | g | % |
|---|---|---|
| Water | 308 | 45.97 |
| Aluminum silicate | 55 | 8.21 |
| Graphite | 50 | 7.46 |
| Iron oxide | 20 | 2.99 |
| Mica | 98 | 14.63 |
| Biocide | 2 | 0.30 |
| Wetting agent | 4 | 0.60 |
| Antifoaming agent | 8 | 1.19 |
| Water | 125 | 18.66 |
| | 670 | 100.00 |

To this base stock, 0.3% Fabutit is added in Example 3, 1.5% Attagel 40 in Example 4 and both 0.3% Fabutit and 1.5% Attagel 40 in Example 5. The results are shown in Table 3. The addition of Fabutit results in a marked increase in the thixotropy, while the viscosity does not increase compared to the base stock. The addition of Attagel 40 has different results. Here, both the viscosity and the thixotropy are drastically increased. Only the combined addition of Fabutit and Attagel 40 in Example 5 surprisingly results in a moderate increase in viscosity in combination with good thixotropy values.

TABLE 3

| | | Yield | | Viscosity |
|---|---|---|---|---|
| | | value | Thixotropy | at 50/s |
| | Composition | [Pa] | [Pa/s] | [mPas] |
| Example 2 | base stock | 1.3 | 6.5 | 82 |
| Example 3 | base stock + 0.3% Fabutit | 1.5 | 43.4 | 70 |
| Example 4 | base stock + 1.5% | 13.4 | 327.6 | 963 |
| | Attagel 40 | | | |
| Example 5 | base stock + 0.3% | 5.8 | 75.5 | 144 |
| | Fabutit + 1.5% Attagel 40 | | | |

In Examples 9, 11, and 13 below it is shown (Table 4) that the favorable thixotropy and/or viscosity values of the present invention can also be obtained in the presence of various binders. Again, the use of Attagel and binder in Examples 6, 7, and 8 show increased thixotropy values, but also a very high viscosity. A polyvinyl acetate copolymer (Airflex; commercially available from Wilhelm E. H. Biesterfeld, Hamburg), oxidized corn starch (commercially available from Carl Arnsperger, Cologne) and a polyvinyl alcohol (polyviol; commercially available as a solution from Wacker Polymer Systems GmbH & Co. KG, Burghausen) are used as binders.

TABLE 4

| | | | | Viscosity |
|---|---|---|---|---|
| | | Yield value | Thixotropy | at 50/s |
| | Composition | [Pa] | [Pa/s] | [mPas] |
| Example 6 | base stock + 1.5% Attagel 40 + | 15.8 | 344.7 | 931 |
| | 1.2% Airflex | | | |
| Example 7 | base stock + 1.5% Attagel 40 + | 25.3 | 404.6 | 1013 |
| | 0.7% corn starch | | | |
| Example 8 | base stock + 1.5% Attagel 40 + | 24.4 | 172.7 | 586 |
| | 2.8% polyviol sol. | | | |
| Example 9 | base stock + 0.3% Fabutit + | 5.1 | 76.7 | 147 |
| | 1.5% Attagel 40 + 1.2% Airflex | | | |
| Example 10 | base stock + 1.5% Attagel 40 + | 4.4 | 72 | 112 |
| | 1.2% Airflex + water (35%) | | | |
| Example 11 | base stock + 0.3% Fabutit + | 8.0 | 93.4 | 217 |
| | 1.5% Attagel 40 + 0.7% corn starch | | | |
| Example 12 | base stock + 1.5% Attagel 40 + | 5.0 | 48 | 106 |
| | 0.7% corn starch + water (30%) | | | |
| Example 13 | base stock + 0.3% Fabutit + | 3.3 | 45.5 | 112 |
| | 1.5% Attagel 40 + 2.8% polyviol sol. | | | |
| Example 14 | base stock + 1.5% Attagel 40 + | 7.3 | 59.2 | 140 |
| | 2.8% polyviol sol. + water (20%) | | | |

Examples 10, 12 and 14 show that according to the present invention, concentrated coating materials can be produced. If the teaching of the present invention is not applied, the viscosity and/or thixotropy properties have to be adjusted by dilution with the corresponding carrier liquid. However, high contents of carrier liquid are unfavorable since the carrier liquid usually has to be removed again.

1. Thixotroping agent comprising a layered silicate and an organically modified phosphate.

2. Thixotroping agent according to claim 1, wherein the layered silicate and the organically modified phosphate are present at a weight ratio in the range of 1:2 to 20:1.

3. Thixotroping agent according to claim 1, wherein the layered silicate is selected from attapulgite and bentonite.

4. Thixotroping agent according to claim 3, wherein the layered silicate is attapulgite.

5. Thixotroping agent according to claim 1, wherein the organically modified phosphate is a neutralized aluminum phosphate.

6. Thixotroping agent according to claim 5, wherein the organically modified phosphate is the hydroxyalkyl ammonium salt of an aluminum phosphate.

7. Coating material comprising a thixotroping agent according to claim 1.

8. Coating material according to claim 7, comprising 0.1 to 10 wt.-% of the layered silicate and 0.1 to 5.0 wt.-% of the organically modified phosphate.

9. Coating material according to claim 8, comprising 0.1 to 5.0 wt.-% of the layered silicate and 0.1 to 2.0 wt.-% of the organically modified phosphate.

10. Coating material according to claim 7, further comprising a carrier liquid, said carrier liquid comprising water as the main component.

11. Coating material according to claim 10, wherein the carrier liquid is water.

12. Coating material according to claim 7, further comprising a refractory material in an amount of 20 to 80 wt. %.

13. Coating material according to claim 12, wherein the refractory material is selected from aluminum silicate, mica, zirconium silicate, graphite, titanium dioxide, calcium carbonate, talcum, quartz, and calcined clay.

14. Coating material according to claim 7, further comprising a pigment in an amount of 20 to 80 wt.-%.

15. Coating material according to claim 7, further comprising a binder in an amount of 0.2 to 50 wt.-%.

16. Coating material according to claim 15, wherein the binder is selected from starch, dextrin, peptides, polyvinyl alcohol, polyacrylic acid, polystyrene-, polyvinyl acetate-polyacrylate dispersions.

17. Coating material according to claim 7, further comprising an additive selected from antifoaming agents and biocides.

18. Process for the production of a coating material, characterized in that a thixotroping agent according to claim 1 is incorporated into a carrier liquid.

19. Process for coating a body with a coating material, comprising the steps of
a) providing a coating material according to claim 7;
b) applying the coating material to a body; and
c) drying the coated body
d) optionally curing the coating material.

20. Process according to claim 19, wherein the body is selected from a core or a mold for use in a foundry, a wall, a ceiling, and a wall or ceiling dressing.

21. Process according to claim 20, wherein the wall or ceiling dressing is wallpaper.

22. Process according to claim 18, wherein the composition is applied to the body by brushing, spraying, dipping or flow coating.

23. Coated body onto which a coating material according to claim 7 has been applied.

24. Coated body according to claim 23, onto which the coating material has been applied by brushing, spraying, dipping or flow coating.

25-26. (canceled)

27. A method of controlling the thixotropy and application behavior of a coating material for a body, comprising:
a) formulating a coating material, and
b) incorporating a thixotroping agent of claim 1 in the coating material in an amount effective to control the thixotropy and application behavior of the coating material.
